(19) United States
(12) Patent Application Publication
(10) Pub. No.: US 2019/0370883 A1
(43) Pub. Date: Dec. 5, 2019

(54) Kitchen Appliance for the at Least Partially Automated Processing of Recipes and Method for Assisting in Purchasing

(71) Applicant: Vorwerk & Co. Interholding GmbH, Wuppertal (DE)

(72) Inventors: Hendrik Koetz, Wetter (DE); Stefan Kraut-Reinkober, Leverkusen (DE); Andrej Mosebach, Bochum (DE); Mirco Pieper, Wuppertal (DE); Anton Reindl, Garmisch-Partenkirchen (DE); Christiane Stach, Radevormwald (DE); Wenjie Yan, Düsseldorf (DE); Sarah Werhahn, Zürich (CH)

(21) Appl. No.: 16/431,323

(22) Filed: Jun. 4, 2019

(30) Foreign Application Priority Data
Jun. 5, 2018 (EP) 18176152.9

(51) Int. Cl. G06Q 30/06; A47J 36/32

(52) U.S. Cl. CPC G06Q 30/0633; A47J 36/32

(57) ABSTRACT

The invention relates to a kitchen appliance (1) for at least partially automated processing of recipes (10), comprising a functional unit (2) for processing ingredients when processing the recipes (10), a user interface (3) for detecting a user input (101.1), an integrated control unit (4), by means of which at least one recipe (10) can be selected as a function of the user input (101.1) and the electrical functional unit (2) can be activated. In addition, the invention concerns a method (100) for assisting a user of a kitchen appliance (1) in purchasing.

The present invention concerns a kitchen appliance for the at least partially automated processing of recipes according to the preamble of the independent device claim as well as a procedure for the purchase support of a user of a kitchen appliance.

It is well known from the state of the art that even in private households there is an increasing degree of automation in different areas of life. In particular, kitchen machines are known to support a user by at least partially automating recipes. It is well known that such kitchen machines can perform certain functions, such as heating food, depending on a user input. The integration of recipe sequences into such kitchen machines offers the advantage that recipes can be individually tailored to the conditions of the kitchen machine and/or the user. It is desirable to continue to support the user in other areas of life related to cooking.

From DE 10 2012 217 004 A1, for example, it is known that you can select a menu on a smartphone and use the menu to create a purchasing list. The menu is then transferred to a cooking device. When planning the purchasing list, however, data from the cooking appliance is not available, since this is carried out externally. In addition, the purchasing list creation function is only available via an external provisioning service, which requires the user to log in, install additional software and/or take other actions. It is therefore desirable to be able to make such functions available to the user when the kitchen appliance is put into operation.

It is therefore a task of the present invention to at least partially eliminate the disadvantages known from the referenced state of the art. In particular, one of the tasks of the present invention is to enable a user to obtain extended support in other areas of life with regard to the preparation of food, in particular by facilitating access to such functions for the user, preferably by putting a kitchen appliance into operation.

The preceding task is solved by a kitchen appliance with the features of claim 1 and a procedure with the features of claim 11. Further features and details of the invention result from the description, the dependent claims and the drawings. Features and details which have been described in connection with the kitchen appliance in accordance with the invention naturally also apply in connection with the procedure in accordance with the invention and vice versa in each case, so that with regard to the disclosure of the individual aspects of the invention, reference is or can always be made to each other.

According to the invention, the kitchen appliance for at least partially automated processing of recipes has a functional unit for processing ingredients when processing recipes. The kitchen appliance further comprises a user interface for detecting a user input and an integrated control unit, by means of which at least one recipe can be selected as a function of the user input and the electrical functional unit can be activated. The integrated control unit is designed in such a way that a recipe-specific list of ingredients for at least one recipe can be determined and made available to an external receiving device in a purchasing list via a device interface connected to the integrated control unit.

In particular, the kitchen appliance is a food processor for preparing food. The electrical functional unit preferably comprises an electrically driven agitator for mixing ingredients and/or an electrical heating element for heating ingredients. The functional unit can therefore be used to automate some or all of the steps involved in processing the recipes. To capture the user input, the user interface may preferably comprise a display unit, in particular a touch display, and/or a rotary knob. This means that at least one recipe from a recipe collection (which can also be extended, see below) can be selected by user input using the user interface. The external receiving device may preferably comprise a mobile device such as a smartphone, tablet and/or the like. Furthermore, it is conceivable that the external receiving device may comprise a server on which the purchasing list is stored. It is also conceivable that a mobile device is indirectly in communication with the control unit by first sending the purchasing list data to a server, which in turn makes the data available to the mobile device. Furthermore, the external receiving device can include a printer which can be connected to the kitchen appliance, e.g. via the external appliance interface, so that the purchasing list can be printed out immediately and the user can conveniently carry the purchasing list with him. The printer can advantageously be a wired printer that can be connected to the kitchen appliance via USB, for example, ensuring fast and secure data transfer. Alternatively, it can be a wirelessly communicating printer, i.e. with a WLAN interface or the like, which therefore does not have to be located directly in the vicinity of the kitchen appliance. Preferably, the printer can be connected to the appliance interface of the kitchen appliance via a network. The device interface may include an interface for wireless and/or wired communication. In particular, the device interface may have a USB interface, network interface, in particular LAN or WLAN interface, mobile radio interface, in particular LTE interface, Bluetooth interface and/or the like.

The integrated control unit is in particular a control unit integrated into the kitchen appliance. It is conceivable that the integrated control unit is designed at least in part as an embedded system, i.e. in particular as an embedded system, in particular whereby the integrated control unit may have a circuit in order to fulfil the intended functions. To determine the recipe-specific ingredients list and make it available in the purchasing list via the device interface of the external receiving device, the integrated control unit preferably has an interface to a memory unit or a memory unit. The recipe-specific ingredient list, the purchasing list and/or the recipe can be stored temporarily in the memory unit. Furthermore, the integrated control unit preferably has a processor which is designed to feed a program sequence for determining the recipe-specific list of ingredients, in particular by analysing the recipe.

The purchasing list may preferably include the list of ingredients and/or be formed from the list of ingredients. It is therefore conceivable that the purchasing list can be supplemented by the user so that, in addition to the ingredients of the recipe-specific ingredient list, further ingredients can be added to the purchasing list manually or automatically. In addition, the purchasing list may include, for example, a sorting of ingredients to help a user find his way around the supermarket.

Thus, the invented kitchen appliance creates a kitchen appliance which, by integrating the control unit, forms a unit easily accessible to the user in order to create the purchasing list. For example, it is not necessary for the user to create the purchasing list on an external device, although it is possible to transfer the purchasing list to such a device in order to conveniently take the purchasing list with him for shopping. With the commissioning of the kitchen appliance, the user can thus also access the function of creating the purchasing list—without detours or additional effort—whereby, in particular, device-specific data is available in a simple manner without the need to exchange data with a server. In particular, device-specific user data, environmental data and/or the like can be taken into account when creating the list of ingredients and/or the purchasing list.

It is also conceivable for a kitchen appliance according to the invention, that the purchasing list can be created by the integrated control unit as a function of the predetermined packaging sizes of the ingredients. Preferably, the packaging sizes can be obtained automatically via the device interface. It is conceivable, that sales points in the vicinity can be identified by determining the location and that common or actually existing packaging sizes can be called up in the sales points. The given packaging sizes can in particular be understood as common packaging sizes which are offered in supermarkets or ordering services. In particular, the specified packaging sizes can also be individual packaging sizes, which are specified by the user or can be obtained from local suppliers via the external device interface. By the given packaging sizes the user automatically finds an orientation, by which he can be further supported in the supermarket and thus further parts of his purchase planning can be relieved. In addition, a specification of packaging sizes can, for example, simplify or even enable automatic ordering of ingredients. In addition, when the purchasing list is made available, the user is already given an overview of how many ingredients he may have to buy too much due to minimum packaging sizes, so that he can take this into account when planning his further meals.

Preferably, for a kitchen appliance according to the invention, it may be possible to bring a memory unit into communication connection with the integrated control unit, in which at least the selected recipe, a predefined recipe collection and/or the purchasing list can be stored. This allows, for example, several recipes to be selected one after the other and/or simultaneously and at least temporarily stored in the memory unit. The predefined recipe collection can already be stored in the memory unit in particular, so that in particular it is permanently available for the user. In particular, the integrated control unit may be in communication with the memory unit. The memory unit can be an integrated memory unit or a memory unit connected to the kitchen appliance. For example, it is conceivable that the memory unit could be connected to the kitchen appliance as a USB stick or SD card or the like. This allows the memory unit to be interchangeable, for example to allow alternative and/or extended recipe collection even after the kitchen appliance has been put into service. Intermediate storage of the purchasing list in the memory unit can, for example, enable the purchasing list to be continued at a later point in time and thus to be supplemented with ingredients for further recipes. So it is conceivable that the purchasing list is called up on a certain weekday when the user goes shopping. Furthermore, it is conceivable that the memory unit is part of an external server which can be connected to the integrated control unit via the device interface. This means that storage space can be swapped out. Furthermore, the provision of a server for the provision of recipes can simplify, for example, the expansion of the recipe collection.

The invention may also provide that the user interface includes a display unit through which the recipe collection and/or the recipe-specific ingredients list and/or the purchasing list can be displayed. In particular, the display can be provided in several sub-segments. This allows the user to check the recipe-specific ingredients list and the purchasing list on the device before it is transferred to the external receiving device in the finished state. In particular, it may be provided that the display unit is designed as a touch display and that the purchasing list and/or the recipe-specific list of ingredients can be edited by the user via the display unit. For example, the user can delete ingredients from the purchasing list at the device if they already have them in stock and/or add further ingredients.

Preferably, for a kitchen appliance according to the invention, it can be provided that at least two recipes can be selected via the user interface, it being possible for a recipe-specific list of ingredients to be determined in each case for each recipe by means of the integrated control unit, it being possible for each recipe-specific list of ingredients to be processed in a separate purchasing list by means of the integrated control unit and/or the recipe-specific lists of ingredients to be combined in the purchasing list by means of the integrated control unit. If a single purchasing list is provided for ingredient lists of several recipes, this has the advantage that the user has a quick overview of how much of each ingredient he has to buy for the entire need for a single purchase. This means that the purchasing list can contain the sum of the ingredients of several recipes or several recipe-specific ingredient lists. In particular, different packaging sizes can also be taken into account, so that, for example, a larger package of a single ingredient can be sufficient to cover the need for two or more recipes. Two separate purchasing lists in turn have the advantage that the user can comfortably decide in the supermarket whether he already wants to do the shopping for a certain recipe or only wants to buy for another recipe and wants to continue the shopping for the first recipe at a later time.

Preferably, the integrated control unit of a kitchen appliance according to the invention can be designed to interpret the selected recipe in such a way that the recipe-specific ingredient list of the selected recipe can be extracted. The interpretation can thus include a text-based analysis of the recipe, whereby the recipe is broken down into individual areas and/or individual words and, for example, the naming of the ingredients can be recognised using a lexicon or a predefined library and assigned to a required quantity. It is also conceivable that the recipe may have metadata that provide the recipe-specific list of ingredients, so that only this metadata is read. Furthermore, it is conceivable that the recipe may include instructions to the user and/or the kitchen appliance which are interpreted by the integrated control unit with regard to the ingredients. Such instructions may include control commands from the kitchen appliance and/or text and/or voice output to the user. This means that the recipes can be easily designed. Furthermore, it may not be necessary for the recipe to be specially prepared for the purchasing list function. Rather, easily created standard recipes can also be used for this function.

In the context of the invention it is also conceivable that the integrated control unit is designed to store a recipe history in the memory unit, wherein the recipe history comprises previously selected recipes and a need for ingredients from the recipe-specific list of ingredients for the purchasing list can be determined by the integrated control unit as a function of the recipe history, in particular on the basis of previously carried out recipes. The recipe history can therefore include previously selected recipes, in particular recipes executed previously. So it is conceivable that the user selects different recipes and these are stored in the recipe history. The display can thus be prioritized, in particular by the integrated control unit, whereby the previously selected recipes of the recipe history are visually highlighted and/or displayed separately from other recipes. Furthermore, the recipe history can include previously performed recipes, so that on the one hand the user behaviour can be traceable on the basis of the recipe history and on the other hand a stock of the user can be determined on the basis of the recipe history. If, for example, the user has already created a purchasing list based on selected recipes, it can be planned that he processes these and that the processing is saved as existing stocks, in particular in the memory unit. If he finally executes the corresponding recipe, a residual stock can be determined, particularly depending on the packaging sizes purchased, which is reflected in the recipe history. The existing ingredients can be used accordingly for newly selected recipes and are preferably not transferred from the recipe-specific ingredients list to the purchasing list. This can significantly increase the efficiency of the use of purchases.

The invention may also provide that the integrated control unit can bring the selected recipe into a deactivated state and only transfer it into an activated state if the integrated control unit receives confirmation of at least partial processing of the purchasing list. In the deactivated state, a recipe may preferably not be executable for a user and/or at least be marked as deactivated. In the activated state, a recipe can preferably be executable for a user and/or at least marked as activated. For example, activated recipes for which the required ingredients are available can be prioritized and displayed to the user. This allows the kitchen appliance to provide the user with an overview of which recipes he can execute at all, thus avoiding a false start of a recipe in which a certain ingredient is not found to be missing until a later cooking step.

Furthermore, in the case of an inventive kitchen appliance, it may be provided that the integrated control unit is designed to automatically convert a unit of measurement of ingredients of the selected recipe as a function of a region for the purchasing list, in particular the region being automatically identifiable by the integrated control unit. The automatic determination of the region can be carried out via the device interface, for example via the IP address. In addition or alternatively a position determination unit can be provided, which can include for example a GPS sensor for the determination of the location data of the kitchen appliance. The unit of measurement can preferably be a unit of measure and/or a unit of weight. Thus it is conceivable that the region “Germany” is determined and the units of measurement of the ingredients, in particular in the purchasing list, are represented in SI units and/or locally usual shopping sizes. If the region “Great Britain” is selected, the integrated control unit can automatically convert it into an Anglo-American measurement system. In addition to or as an alternative to the automatic determination of the region, it may be provided that the region is preset and/or can be preset by the user.

It is also conceivable that the integrated control unit is designed to trigger an order automatically by sending at least part of the purchasing list via the appliance interface. For example, an external service can be notified by the kitchen appliance about the part of the purchasing list that has been sent, so that an order is placed automatically. Thus it can be sufficient for the user to select certain recipes for which the ingredients are automatically ordered and delivered. This can further improve the ease of access to this function of the kitchen appliance as well as the comfort for the user.

According to a further aspect of the invention, a procedure is claimed for the purchase support of a user of a kitchen appliance, in particular a kitchen appliance conforming to the invention. The procedure comprises the following steps:
recording a user entry,
determining at least one recipe selected by the user as a function of the user input ingredient list by a control unit integrated in the kitchen appliance,
determining a recipe-specific list of ingredients of the at least one selected recipe by the integrated control unit,
creation of a purchasing list from at least the recipe-specific ingredients list by the integrated control unit,
sending the purchasing list to an external receiving device.

Thus, the method according to the invention has the same advantages as described in detail with regard to a kitchen appliance according to the invention. The recording of the user input can preferably be carried out via a user interface of the kitchen appliance. Furthermore, the determination of the selected recipe and the recipe-specific list of ingredients can also be carried out by the integrated control unit. The purchasing list is preferably sent via an interface connected to the integrated control unit. This means that the user's purchasing support can already be accessible to the user when the kitchen appliance is put into operation, in particular without the user having to carry out a data comparison with a server and/or his profile. Furthermore it finds the function in the kitchen appliance and thus in a central place. By sending the purchasing list, the purchasing list can also be made available to the user in a convenient manner.

In the context of the invention, it is also conceivable that the procedure may include the following step:
Save the selected recipe, the recipe-specific ingredient list and/or the purchasing list.

Storage can preferably take place in a memory unit and be temporary or permanent. This ensures later access to the respective data. This may, for example, allow several recipes to be selected one after the other or the list of ingredients and/or the purchasing list to be changed subsequently.

In the case of an inventive method, it may also be provided that the determination of the recipe-specific list of ingredients includes an interpretation of the recipe by the integrated control unit so that the recipe-specific list of ingredients of the selected recipe is extracted. For example, individual text modules of the recipe can be separated and assigned to the recipe-specific ingredient list. For this purpose, for example, the individual building blocks of the recipe can be identified, which can preferably be text-based. Extraction may be based on instructions from the recipe, in particular audiovisual instructions and/or text-based instructions. This means, for example, that it may not be necessary for the recipes to be specially prepared for the purchasing list function.

Furthermore, an inventive method may provide that at least two recipes selected by the user are determined on the basis of one or more user inputs and that a recipe-specific list of ingredients is determined for each recipe selected, whereby a separate purchasing list is created for each recipe-specific list of ingredients or the recipe-specific lists of ingredients are merged in the purchasing list. This allows a single purchasing list to be used by the user for purchasing to cover multiple recipes by purchasing. Alternatively, a separate purchasing list can be provided for each recipe in order to differentiate between the recipes in the supermarket, for example.

In the context of the invention, it is also conceivable that the procedure may include the following steps:
Saving a recipe history comprising previously selected recipes,
Determine a need for ingredients from the recipe-specific ingredient list for the purchasing list using the recipe history.

The recipe history can be saved, for example, whenever a new recipe is selected and/or executed by the user. Thus, the recipe history, especially in combination with the user's previous shopping behaviour, can be used to determine the need for the ingredients. This means, for example, that stocks can be deducted from the recipe-specific ingredient lists of newly selected recipes in order to keep the purchasing list up-to-date. This can result in an efficient use of ingredients and/or shopping time.

It is also conceivable that a procedure according to the invention includes the following step:
Automatic conversion of a unit of measurement of ingredients of the selected recipe for the purchasing list depending on a region,
   in particular wherein an automatic determination of the region is effected by the integrated control unit. Thus, the unit of measurement of the ingredients can be tailored directly to the user's needs when shopping and the kitchen appliance can be suitable for use in different countries and/or regions. The automatic conversion can preferably also be carried out by the integrated control unit, so that this process step also takes place directly in the kitchen appliance. The automatic determination of the region can be performed by determining an IP address, a location, language setting, recognition of a user or the like.

Preferably, in the case of a process according to the invention, the process may include the following step:
Automatic triggering of an order for ingredients from at least part of the purchasing list.

Preferably, the entire purchasing list can be sent to an external service for automatic triggering of the order. In particular, a confirmation from the user that the order is to be triggered can be obtained beforehand. This means that the user can be supported in his purchasing behaviour by further automation, especially if the order results in a delivery service delivering the required ingredients.

The invention may also provide for the procedure to include the following step:
Carrying out an automatic cooking operation based on a selected recipe, in particular after confirmation of at least partial processing of the purchasing list.

Thus the confirmation of the at least partial processing of the purchasing list may preferably be required in order to start the automatic cooking operation manually. The automatic cooking operation can include the specification of individual recipe steps to be carried out by the kitchen appliance. Furthermore, the automatic cooking operation can include the setting of certain operating parameters for the next cooking section, which is merely started by the user, for example via the user interface. This makes it easy to integrate purchasing into the cooking operation so that the user at least receives a warning if not all ingredients have been purchased and/or registered. For example, the confirmation can be done automatically when the purchasing list is finished, or manually by displaying a warning to the user when the user wants to start cooking but not all purchases are registered.

The process steps described above can be carried out in any order or in the order described. In particular, individual steps or all process steps can be repeated.

Further advantages, features and details of the invention result from the following description, in which examples of the execution of the invention are described in detail with reference to the drawings. Features mentioned in the claims and in the description may be essential to the invention either individually or in any combination.

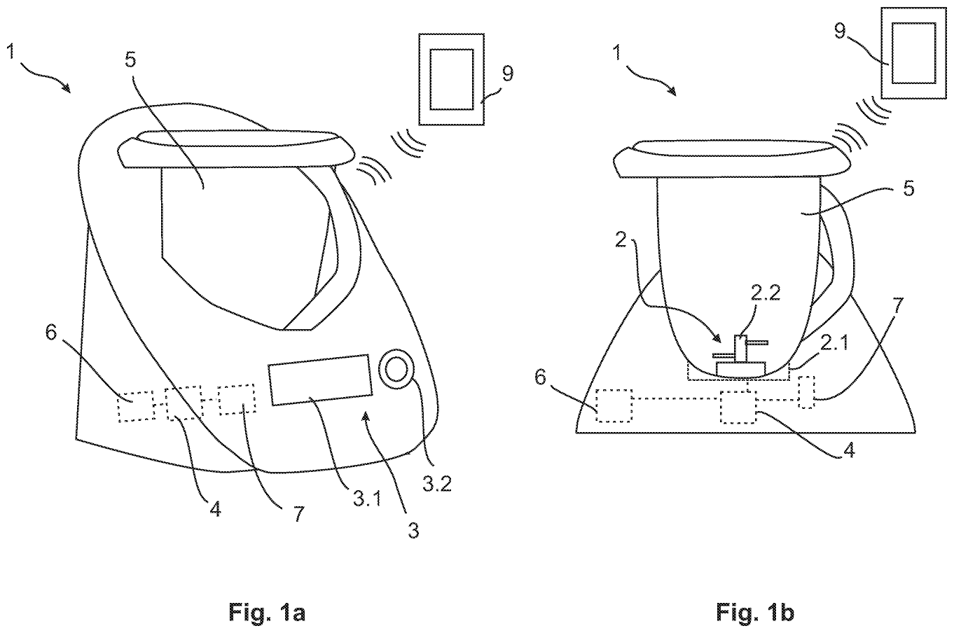

FIGS. 1a-b a kitchen appliance according to the invention in a schematic representation in a first example,

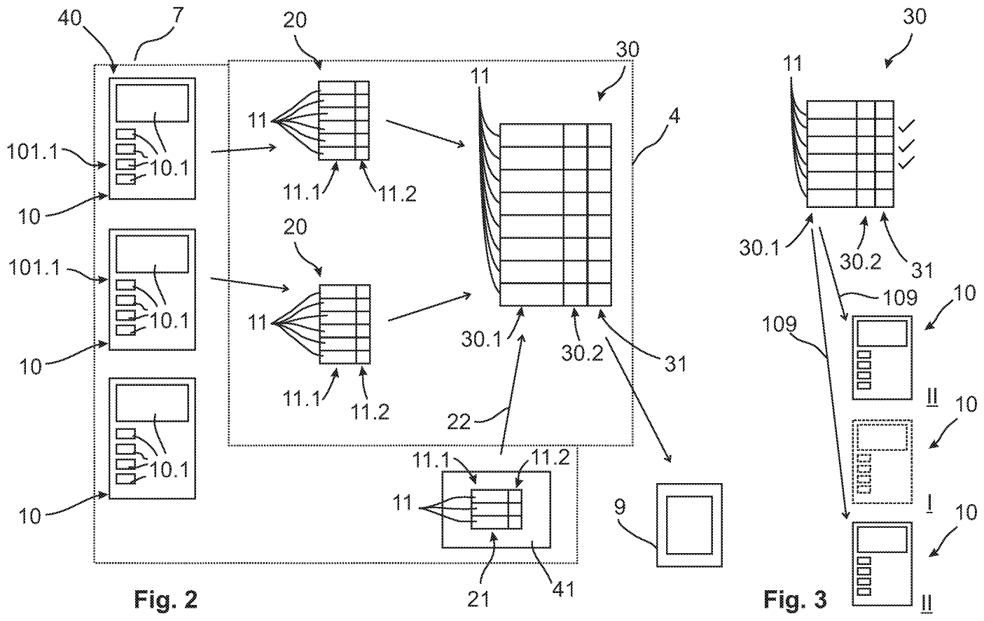

FIG. 2 a data structure of an integrated control unit of the invented kitchen appliance of the first execution example in schematic representation,

FIG. 3 Different recipe states for an invented kitchen appliance in a further example in schematic representation,

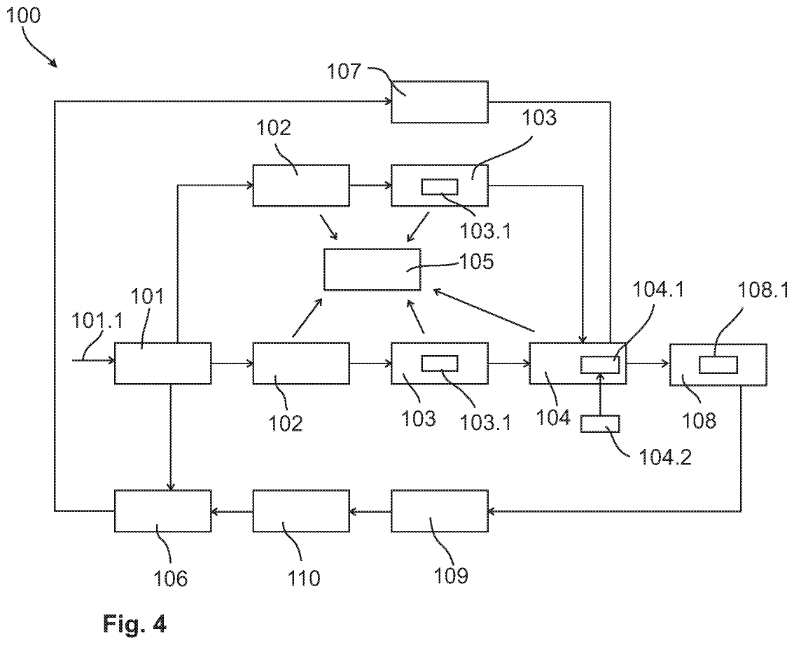

FIG. 4 shows a procedure according to the invention in a schematic representation of the process steps in a further example.

In the following figures, the identical reference signs are used for the same technical characteristics, even for different execution examples.

FIGS. 1a and 1b show a kitchen appliance 1 for at least partially automating the processing of recipes 10 in accordance with the invention. Kitchen appliance 1 has a cooking vessel 5 for holding ingredients 11 and a functional unit 2 for processing ingredients 11 when processing recipes 10. Functional unit 2 comprises an electric heating element 2.1 and an electric agitator 2.2. The heating element 2.1 can be used to heat ingredients 11 in a cooking vessel 5 of kitchen appliance 1 and the agitator 2.2 can be used to crush and/or mix ingredients 11. Function unit 2 can be controlled by an integrated control unit 4, which can at least partially automate recipes 10. For this purpose, the integrated control unit 4 is also in communication connection with a user interface 3 for recording user input 101.1. The user interface 3 includes a display unit 3.1 and a rotary knob 3.2 to provide the user input 101.1 of the integrated control unit 4. In addition, the integrated control unit 4 is connected to a memory unit 7 in which data can be stored. In the example shown, the memory unit 7 is an integrated memory unit. In addition or alternatively, however, it is conceivable that the memory unit 7 comprises a memory chip which is detachably connected to the kitchen appliance 1 or a server which is in communication connection with the kitchen appliance 1 via the device interface 6. This allows the data to be transported or carried along and/or exchanged by the user. In addition, a device interface 6 is connected to the integrated control unit 4, so that the integrated control unit 4 can be connected to an external receiving device 9. The device interface 6 can be a network interface, Bluetooth interface or similar. The integrated control unit 4 is further designed such that a recipe-specific ingredient list 20 of the at least one recipe 10 selected by the user can be determined and made available to the external receiving device 9 in a purchasing list 30 via the device interface 6.

FIG. 2 shows a schematic representation of a data structure for the creation of the purchasing list 30 by the integrated control unit 4. A recipe collection 40 is provided, which is preferably stored in the memory unit 7. The recipe collection 40 contains several recipes 10, of which the user can, for example, select two recipes 10 by entering user inputs 101.1. The recipes 10 have different recipe elements 10.1, which can include instructions to the user, operating parameters of the kitchen appliance 1 and/or the like. In order to create a recipe-specific ingredient list 20 for each selected recipe 10, the recipes 10 are interpreted by the integrated control unit 4, whereby the recipe elements 10.1 containing the ingredients 11 are isolated and the individual ingredients 11 are finally extracted from the respective recipe elements 10.1. In particular, each specific list of ingredients 20 may include for each ingredient 11 a designation 11.1 and a quantity 11.2, each quantity 11.2 being assigned to a designation 11.1. The quantity 11.2 may be expressed in a given unit of measurement. Finally, the recipe-specific ingredient lists 20 are preferably combined to form a single purchasing list 30, with each ingredient 11 required being assigned a purchasing item 30.1 and a purchasing quantity 30.2. Preferably, each ingredient can also be assigned a required packaging size 31, which can in particular be greater than or equal to the purchasing quantity 30.2. If also existing stocks of the user are to be considered, it can be provided that a stock-specific list of ingredients 21 is provided, which is considered by the integrated control unit 4 of the kitchen appliance 1 with the production of the purchasing list 30. In addition, the stock-specific list of ingredients 21 and the recipe-specific lists of ingredients 20 can each contain several ingredients 11, which are stored with the respective designations 11.1 and 11.2. In particular, the stock-specific list of ingredients 21 can be stored in the memory unit 7 and called up by the integrated control unit 4. In contrast to the recipe-specific lists of ingredients 20, entries in the stock-specific list of ingredients 21 lead to a subtraction of the quantity in the purchasing list 30, so that ingredients 11 that are already in stock no longer have to be purchased and are therefore not reflected in the purchasing list 30. Thus, the stock-specific list of ingredients 21 can identify a need for certain ingredients and, in particular, differ from the quantities indicated in the recipe-specific lists of ingredients 20. The stock-specific list of ingredients 21 can in particular result from a recipe history 41 in which previously selected and/or previously executed recipes 10 of the user can be stored. In particular, previous processing of previous purchasing lists 30 or earlier versions of purchasing list 30 can be taken into account. The purchasing list 30 can then be sent by the integrated control unit 4 to the external receiving device 9 via the device interface 6.

FIG. 3 also shows different states I, II of recipes 10 as they can be understood by the integrated control unit 4. So it is conceivable that the recipes 10 are transferred after the selection by a user input 101.1 into a deactivated state I. If, in addition, a confirmation 109 is issued about a processing of a purchasing list 30 for the respective recipe 10, it is intended to transfer this into an activated state II. The activated state II can include a highlighting of the recipe 10 on a display unit 3.1 of a kitchen appliance 1. This allows the user to quickly determine which recipes 10 he has already purchased all the required ingredients for 11. Confirmation 109 can, for example, be carried out via a device interface 6 of kitchen appliance 1, whereby an external receiving device 9 preferably sends the confirmation to kitchen appliance 1. For example, if the user wants to call up a recipe 10 in deactivated state I to execute it, a warning may be given and the user must first manually confirm the presence of all ingredients.

FIG. 4 also shows a method 100 according to the invention in a schematic representation of the process steps. The first step is the recording 101 of a user input 101.1, by means of which a user selects a recipe 10. The selection of the recipe 10 at data level is made by an integrated control unit 4 of the kitchen appliance 1 via a determination 102 of at least one recipe 10 selected by the user. In the present representation two user inputs 101.1 and thus a determination 102 of two recipes 10 are made. A determination 103 of a recipe-specific list of ingredients 20 is also executed as a function of each of the selected recipes 10, wherein the recipes 10 each being interpreted by the integrated control unit 4 in order to produce the recipe-specific list of ingredients 20. Interpretation 103.1 may, for example, include decomposing recipe 10 into text blocks and/or lead to the determination 103 of ingredients 11 from metadata of recipes 10. The integrated control unit 4 then creates 104 a purchasing list 30 from the recipe-specific lists of ingredients 20. To create the purchasing list 30, a determination 104.2 of a region can be performed, whereupon a conversion 104.1 of units of measure of the recipe-specific lists of ingredients 20 is executed. For example, if the recipe 10 was created in the SI unit system, but the region “Great Britain” was determined, a unit conversion to an Anglo-American unit system can be performed automatically to automatically show the user the correct purchase quantity. In addition, a recipe history 41 can be used to determine 107 a need 22 of ingredients 11 for the purchasing list 30. For example, available quantities of ingredients can be subtracted from recipe-specific lists of ingredients 20 to create purchasing list 30.

Preferably, the selected recipes 10, the recipe-specific lists of ingredients 20 and/or the purchasing list 30 can be made available for a later time by storing 105 in a memory unit 7. Then a sending 108 to an external receiving device 9 of the purchasing list 30 can be performed to make the purchasing list 30 available to the user. For example, the external receiving device may include a smartphone, a tablet, a server, a computer, or the like. In particular, sending 108 of the purchasing list 30 may include triggering of an order 108.1, whereby the purchasing list 30 may be sent at least in part to a delivery service to enable the user to place the order automatically. By automatic ordering and/or manual user input 101.1, it is also possible to confirm 109 that the purchasing list 30 has been processed, which may preferably be necessary for automatic cooking of a recipe 10. When performing 110 one of the recipes 10, a saving 106 of this status can be noted in the recipe history 41, so that the need 22 can be updated according to the consumed ingredients 11. In this example, the purchasing list 30 is represented as a single purchasing list, whereby it is additionally or alternatively also conceivable that a single purchasing list is created for each recipe 10, so that the user can access different purchasing lists for individual recipes. Furthermore, it is conceivable that the method 100 shown in FIG. 4 may be carried out on a kitchen appliance 1 according to the first embodiment.

The preceding explanation of the forms of execution describes the present invention exclusively in the context of examples. Of course, individual features of the design forms can be freely combined with each other, if technically reasonable, without leaving the scope of the present invention.

### LIST OF REFERENCE SIGNS

1 kitchen appliance
2 functional unit
2.1 heating element
2.2 agitator
3 user interface
3.1 display unit
3.2 rotary knob
4 integrated control unit
5 cooking vessel
6 device interface
7 memory unit
9 external receiving device
10 recipe
10.1 recipe element
11 ingredient
11.1 designation
11.2 quantity
20 recipe-specific lists of ingredients
21 stocklist of ingredients
22 need
30 purchasing list
30.1 purchasing item
30.2 purchasing quantity
31 packaging size
40 recipe collection
41 recipe history
100 method
101 recording of 101.1
101.1 user input
102 determination of 10
103 determination of 20
103.1 interpretation of 10
104 creating 30
104.1 converting
104.2 determining a region
105 storing of 10, 20 and/or 30
106 saving of 41
107 determining a need of 11
108 sending of 30
108.1 triggering an order
109 confirmation of processing
110 performing of 10
I deactivated state
II activated state

1. Kitchen appliance for the at least partially automated processing of recipes, comprising
a functional unit for processing ingredients when processing the recipes,
a user interface for detecting a user input,
an integrated control unit, by means of which at least one recipe can be selected as a function of the user input and the electrical functional unit can be activated,
wherein the integrated control unit is designed such that a recipe-specific list of ingredients of the at least one recipe can be determined and made available to an external receiving device in a purchasing list via a device interface connected to the integrated control unit.

2. Kitchen appliance according to claim 1,
wherein the purchasing list can be created by the integrated control unit as a function of predetermined packaging sizes of the ingredients.

3. Kitchen appliance according to claim 1,
wherein a memory unit can be brought into communication connection with the integrated control unit, in which at least the selected recipe, at least one of a predefined recipe collection or the purchasing list can be stored.

4. Kitchen appliance according to claim 1,
wherein the user interface comprises a display unit by means of which at least one of the recipe collection or the recipe-specific list of ingredients or the purchasing list can be displayed.

5. Kitchen appliance according to claim 1,
wherein at least two recipes can be selected via the user interface, wherein a recipe-specific list of ingredients can be determined in each case for each recipe by the integrated control unit, wherein each recipe-specific list of ingredients can be processed in at least one of a separate purchasing list or the recipe-specific lists of ingredients can be combined in the purchasing list by the integrated control unit.

6. Kitchen appliance according to claim 1,
wherein the integrated control unit is designed to interpret the selected recipe in such a way that the recipe-specific list of ingredients of the selected recipe can be extracted.

7. Kitchen appliance according to claim 1,
wherein the integrated control unit is designed to store a recipe history in the memory unit, the recipe history comprising previously selected recipes, and the integrated control unit can determine, as a function of the recipe history, a need for ingredients from the recipe-specific list of ingredients for the purchasing list.

8. Kitchen appliance according to claim 1,
wherein the selected recipe can be brought into a deactivated state by the integrated control unit and can only be transferred into an activated state when the integrated control unit receives a confirmation of an at least partial processing of the purchasing list.

9. Kitchen appliance according to claim 1,
wherein the integrated control unit is designed to automatically convert a unit of measurement of ingredients of the selected recipe as a function of a region for the purchasing list.

10. Kitchen appliance according to claim 1,
wherein the integrated control unit is designed to trigger an order automatically by sending at least part of the purchasing list via the device interface.

11. Method for assisting a user of a kitchen appliance in purchasing, comprising the following steps:
recording a user input,
determining at least one recipe selected by the user in dependence on the user input by a control unit integrated in the kitchen appliance,
determining a recipe-specific list of ingredients of the at least one selected recipe by the integrated control unit,
creation of a purchasing list from at least the recipe-specific list of ingredients by the integrated control unit,
sending the purchasing list to an external receiving device.

12. Method according to claim 11,
wherein the method comprises the following step:
storing at least one of the selected recipe, the recipe-specific list of ingredients or the purchasing list.

13. Method according to claim 11,
wherein the determination of the recipe-specific list of ingredients comprises an interpretation of the recipe by the integrated control unit so that the recipe-specific list of ingredients of the selected recipe is extracted.

14. Method according to claim 11,
wherein at least two recipes selected by the user are determined as a function of one or more user inputs and a recipe-specific list of ingredients is determined for each selected recipe, a separate purchasing list being created for each recipe-specific list of ingredients or the recipe-specific lists of ingredients being combined in the purchasing list.

15. Method according to claim 11,
wherein the method comprises the following steps:
storing a recipe history comprising previously selected recipes,
determining a need for ingredients from the recipe-specific list of ingredients for the purchasing list using the recipe history.

16. Method according to claim 11,
wherein the method comprises the following step:
Automatic conversion of a unit of measure of ingredients of the selected recipe for the purchasing list depending on a region.

17. Method according to claim 11,
wherein the method comprises the following step:
Automatic triggering of an order of ingredients of at least part of the purchasing list.

18. Method according to claim 11,
wherein the method comprises the following step:
carrying out an automatic cooking operation on the basis of the selected recipe.

19. Kitchen appliance according to claim 2,
wherein the packaging sizes are being automatically obtainable via the device interface.

20. Method according to claim 11,
wherein the kitchen appliance for the at least partially automated processing of recipes comprises a functional unit for processing ingredients when processing the recipes, a user interface for detecting a user input, an integrated control unit, by means of which at least one recipe can be selected as a function of the user input and the electrical functional unit can be activated,
wherein the integrated control unit is designed such that a recipe-specific list of ingredients of the at least one recipe can be determined and made available to an external receiving device in a purchasing list via a device interface connected to the integrated control unit.
